(19) United States
(12) Patent Application Publication
(10) Pub. No.: US 2008/0222567 A1
(43) Pub. Date: Sep. 11, 2008

(54) Apparatus with Multiple Highlights

(75) Inventor: Johan Thoresson, Goteborg (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/088,539

(22) PCT Filed: Sep. 14, 2006
(86) PCT No.: PCT/EP2006/066349

§ 371 Date: Mar. 28, 2008

Related U.S. Application Data
(60) Provisional application No. 60/735,807, filed on Nov. 10, 2005.

(30) Foreign Application Priority Data
Sep. 28, 2005 (EP) 05108962.1

(51) Int. Cl. G06F 3/048

(52) U.S. Cl. 715/823

(57) ABSTRACT

The invention relates to an apparatus (3) with a display, in which several items are high-lighted in a pattern (6) at the same time. The pattern of highlights may by moved in parallel by means of a navigation device (3), decreasing the number of steps to move in a matrix. Then one of the items may be selected by means of one or a few dedicated keys (7) or softkeys (8a, 8b).

### FIELD OF THE INVENTION

The present invention relates to an apparatus, such as a mobile telephone with a non-touch screen, in which more than one item displayed on the a screen are highlighted simultaneously. One highlighted item may be selected by means of dedicated selection keys or softkeys.

### STATE OF THE ART

In handheld devices with non-touch screens, navigation in lists and matrixes is a central part of the user interface and is usually based on a logical and physical highlight that distinguishes one item from another. The highlight can be controlled with some sort of navigation input device, such as a joystick, rocker key or disc jog etc. There are typically also a number of hard keys or softkeys, context sensitive or not, that relate to the item that is highlighted, enabling the user to perform actions of different kinds with the highlighted item. Typically, there are one or two actions that can be performed immediately and other actions available can be found in an option or “more” list.

The problem with the approach where a highlight is moved between items, is that when a list or matrix grows to more than 10 to 15 items it may take some time to move the highlight to the item that you are looking for. A specific problem is inputting text with no numeric keys available. A common solution for this is to bring up a virtual, matrix spaced keyboard, but those are often slow as they are typically big matrixes with many options, and therefore there is often a long distance to navigate to the character you want to enter. This problem is more pronounced with phones having different form factors, such as jack knife and slider phones, where the ordinary number keypad cannot be accessed during parts of the interaction as the phone is “closed”, in other words, the key pad is hidden. However, when the phone is closed, the softkeys and the navigation device are still accessible. A typical jack knife phone is shown in FIG. 1.

Known solutions for navigating in lists and matrixes effectively include number key short cuts. For example, in some mobile phones the keys with 1-9, # and * are used as short cuts or accelerators to access items in the corresponding list or matrix position, according to a numeric order or physical location of the item on the screen. The problem with this approach is that there are only twelve keys that can be assigned, and that they are not always accessible, such as with a closed slider or jack knife phone.

A similar solution is used in the phone book, where letters selected by means of the ordinary keys are used for single letter or multi letter search. Another solution is that the speeds with which the highlight moves in the lists and matrixes are increased if a direction key is pressed and held.

One text input navigation system from Magellan is based on an 8-way navigation key. The keyboard is divided in 8 sections, each with 8 sub-sections, i.e. 8 character keys. For the first level, as soon as one direction is selected with the navigation device, the corresponding sub-section is selected, and by pressing a direction on the navigation key again a corresponding character is selected.

### SUMMARY OF THE INVENTION

The present invention proposes to solve this problem by using multiple highlights, i.e. several items are highlighted in a pattern at the same time. The pattern of highlights may by moved in parallel, decreasing the number of steps to move in a matrix. Then one of the items may be selected by means of one or a few dedicated keys or softkeys.

The invention provides an apparatus comprising:
a display unit with a screen capable of displaying lists and matrices with highlighted selectable items;
a control unit managing operations of the apparatus and capable of controlling the display unit;
input means connected to the control unit and comprising a navigation device and keys for moving highlights and selecting items.

According to the invention, the control unit is arranged to cause the display unit to display items of which a number is highlighted in a defined pattern, each such highlighted item representing a selectable item, and being associated with at least one selection key of the input means, and the highlight pattern being movable by means of the navigation device.

In one embodiment, the input means comprises a number of dedicated selection keys.

Suitably, the input means comprises dedicated selection keys placed around the navigation device, and the highlight pattern is reflecting the placement of the selection keys.

Preferably, the highlight pattern comprises four highlighted selectable items, and the input means comprises four dedicated selection keys.

In another embodiment, the navigation device is assigned softkey functions to act as selection key.

Suitably, the position of the highlight pattern first is selected and confirmed by means of the navigation device, then one of the highlighted selectable items are selected by means of the navigation device.

Preferably, the highlight pattern comprises three highlighted selectable items.

In a further embodiment, the input means comprises function keys, of which a number are assigned softkey functions to act as selection keys.

Preferably, the highlight pattern comprises three highlighted selectable items, and the softkey functions to act as selection keys are assigned to two function keys and to the navigation device.

Each selectable item may be highlighted with a different appearance, such as colour.

The apparatus may be a portable telephone, a pager, a communicator, a smart phone, or an electronic organiser.

### BRIEF DESCRIPTION OF THE DRAWINGS

The invention will be described in detail below with reference to the attached drawings, in which:

FIG. 1 is a front view of a typical mobile telephone of the jack knife type,

FIG. 2 is a schematic front view of a first embodiment of the invention,

FIGS. 3A to 3F are views of a virtual keyboard with a pattern of keys highlighted at different locations,

FIG. 4 is a schematic front view of a second embodiment of the invention, and

FIG. 5 is a schematic front view of a third embodiment of the invention.

### DETAILED DESCRIPTION OF PREFERRED EMBODIMENTS

The invention will be described with a mobile telephone as an example. The invention is equally applicable to other devices, such as pagers, communicators, smart phones and electronic organisers. This disclosure will concentrate on the technical aspects relevant to the invention, while other functions necessary for the operation of the device may be conventional.

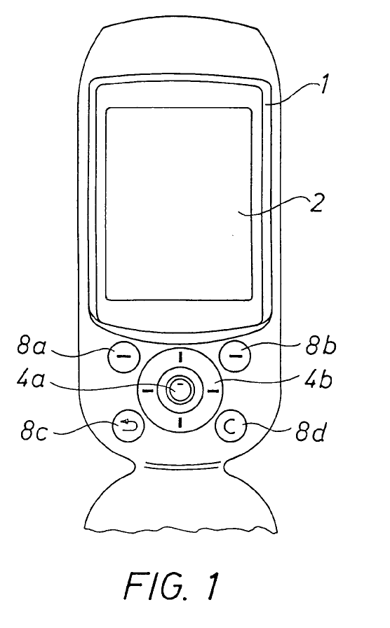

FIG. 1 shows an example of a mobile telephone of the jack knife type. The apparatus 1 has a relatively large display unit with a screen 2, a navigation device here represented by a centre button 4a and a ring 4b that may be activated in four different directions, up, down, right and left. The apparatus also includes a number of function keys, a top left key 8a and a top right key 8b, usually having a function depending on the context, and two lower keys, a back key 8c and a clear key 8d.

Of course, the apparatus includes a control unit (not shown) managing operations of the apparatus and capable of controlling the display unit when the user inputs commands by means of the input means. The apparatus 1 also has the ordinary number keys 1-9, * and #. However, these keys are hidden in the closed state of the apparatus. The user has to open the phone by rotating the lower part relative to the upper part, shown in the figure. In a mobile phone of the slider type, the number keys are of course placed on a slidable part.

Generally, the present invention includes three different embodiments of the suggested solution. All three address matrix navigation in general, and are used to navigate and interact with a virtual on-screen QWERTY keyboard in an apparatus in a closed mode. The same principle can be used for other navigations as well, such as navigating in a desktop type of display with general items.

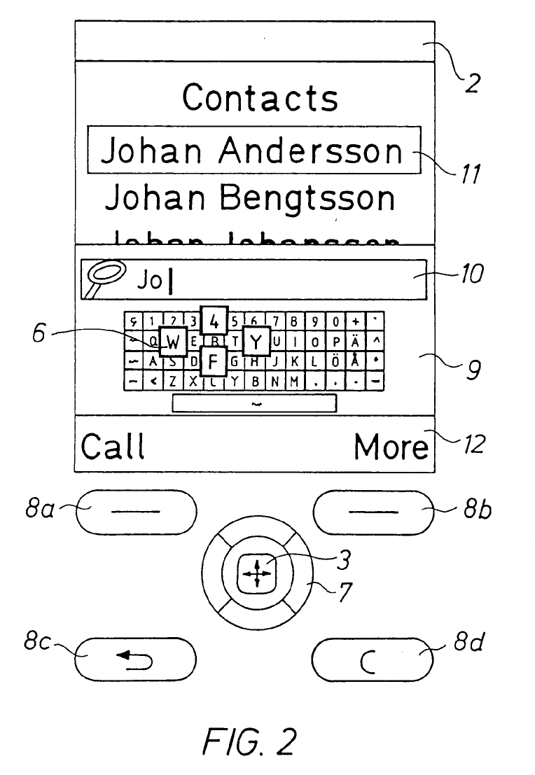

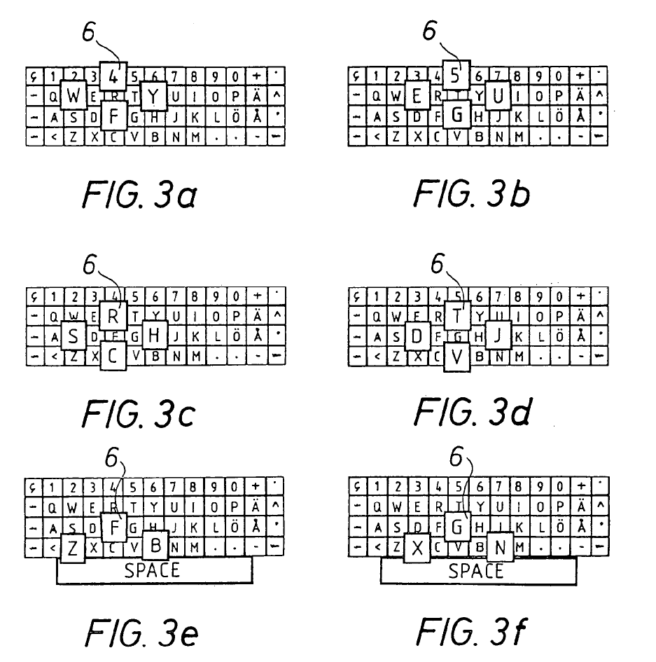

The first embodiment is described with reference to FIG. 2 and FIGS. 3A to 3F. In this embodiment, a number of dedicated selection keys have been provided on the apparatus.

FIG. 2 shows the display 2 with keys below. The display 2 is currently showing part of a contact list 11. A virtual QWERTY keyboard 9, with all the usual characters, is shown in one field. Already selected characters are shown in a search field 10, and one row of the contact list 11, corresponding to the search field 10, is highlighted. The apparatus includes the usual function keys 8a to 8d, of which the two top keys 8a and 8b have the softkey functions as displayed in the softkey field 12.

In this embodiment, four items 6 are highlighted in a predetermined pattern, and the input means is enhanced with four dedicated selection keys 7 to enable the user to select the different highlighted items 6. Each of the selection keys is associated with one of the items 6 according to their positions. Thus, the top selection key 7 corresponds to the top highlighted item etc. The highlights and the keys 7 may also be colour coded, such that each highlight has the same colour as the selection key that is mapped to it.

When one of the election keys 7 is pressed, the character highlighted by the corresponding highlight is added to the search field 10 and what is highlighted in the contact list 11 is preferably updated instantly.

When the user interacts with the navigation device, in the case shown a joystick 3, all highlights are moved around in parallel, as shown in FIGS. 3A to 3F. For example, if the user moves the joystick 3 to the right, or all four highlights are moved one step to the right, as in FIG. 3A to 3B, if the joystick is moved down, all highlights are moved down one step, as between FIG. 3A to 3C, and 3C to 3E, and FIG. 3B to 3D, and FIG. 3D to 3F.

Suitably, the pattern of the highlights 6 are arranged as shown in the FIGS. 3A to 3F, in other words, the distance between the left and right highlight is four steps, and between the top and lower highlight is two steps. Other arrangements are of course also possible, depending on the matrix displayed.

The added multiple highlights have made this input much faster and more efficient, as the distance to the character you want to type is always one step less, or at least as close, then if you have only one highlight.

If the user e.g. wants to write the name “Erik” he would only need to move the joystick two times after moving the left highlight to the “E”. The sequence would be:

1. move the highlights so that the left highlight is on “E”

2. press the left selection key—“E” is typed in

3. move the highlights one step to the right

4. press the left key to enter “R”—“ER” is typed in

5. press the right key to enter “I”—“ERI” is typed in

6. move the highlights one step down

7. press the right key to enter “K”—“ERIK” is typed in

The same sequence with only one highlight would require six joystick presses after first moving the highlight to “E”.

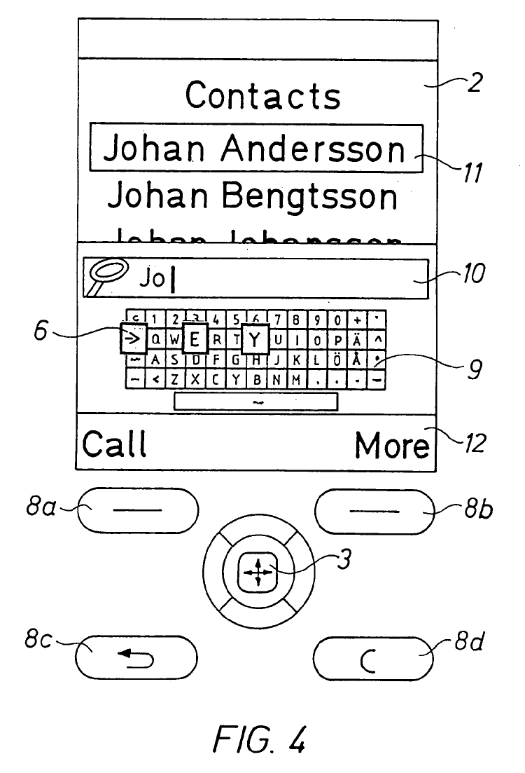

The second embodiment of the invention is described with reference to FIG. 4. This embodiment uses the conventional keys, keeping all softkey functionality in the given interaction situation. That is, the call and more functions are maintained. Instead, extra softkey functions are assigned to the navigation device, here illustrated by means of a joystick 3. A navigation device with a centre button and a ring as shown in FIG. 1 could also be used. No dedicated selection keys have to be added.

The display 2 contains the same fields as discussed with reference to FIG. 2, denoted by the same reference numerals. However, the highlight pattern 6 here only comprises three keys. The pattern comprises one main highlight and two weaker highlights, placed on a horizontal line. The main highlight marks the character that will be entered when pressing centre-select on the navigation device. The main highlight is moved by moving the navigation device to the right or the left.

The pattern 6 is moved by means of the joystick 3. The joystick 3 also has an added function of confirming the position of the pattern 6 with a press-centre-select.

Thus, in this second embodiment, the selection of an actual character is a two step action:

first, after moving the pattern to a wanted position, which highlights the character you want to enter with any of the highlights, centre-select on the joystick is pressed to confirm the position of the pattern,

second, make sure that the main highlight, i.e. the darker one, is on the character that you want to enter, then press centre-select again.

To write “ERIK” would in this case take three joystick moves:

1. press joystick-centre to confirm position

2. press joystick-centre to select “E”

3. move joystick right

4. press joystick-centre to confirm position

5. press joystick-centre to select “R”

6. move joystick right

7. press joystick-centre to confirm position

8. move joystick right to move the main highlight

9. press joystick-centre to select “I”

10.move joystick down

11.press joystick-centre to confirm position

12.press joystick-centre to select “K”

In this second embodiment, multiple highlights may be used without having a dedicated key to each highlight. However, compared to the first embodiment, the number of presses on the selection key is increased.

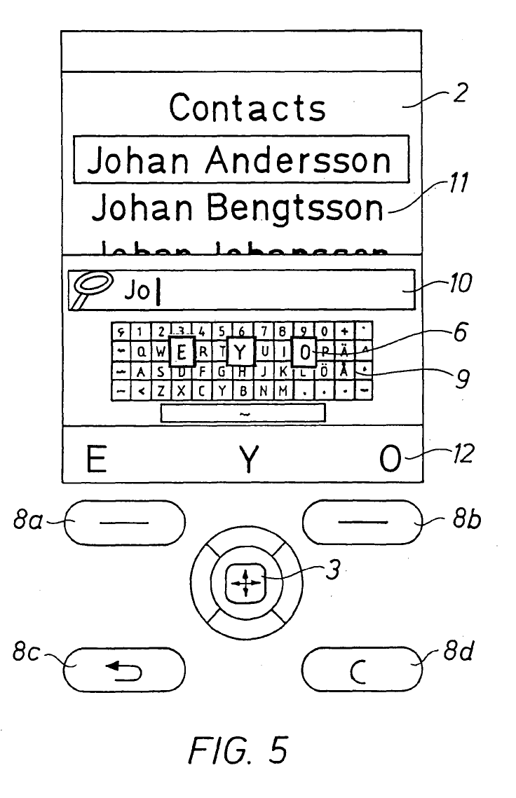

A third embodiment of the present invention is described with reference to FIG. 5. The third embodiment uses the conventional keys, but introduces an input mode, into which the user will have to enter before starting the text input. When the text input is done, the back key 8c is used to exit the input mode, enabling usual softkey functions of the keys 8a and 8b.

As may be seen from FIG. 5, the display 2 contains the same fields as the previous embodiments, denoted by the same reference numerals. In the third embodiment, the user has to enter an input mode before starting the input, which means that both the navigation means, e.g. the joystick 3, and the already existing softkeys 8a and 8b can be used as selection keys. The input mode may for example be reached in the normal mode as an option in the “more” menu, reached be means of the top-right softkey 8b.

Like the second embodiment, the highlight pattern 6 consists of three highlighted items, placed on a horizontal line. In this embodiment, the joystick 3 and the two softkeys 8a and 8b are assigned to one highlight each. The functions of the keys are shown in the softkey field 12, as shown in FIG. 5. To leave the mode, the user e.g. has to press the back key 8c to be able to perform an action of a found contact, when the softkeys 8a and 8b has been reassigned to the functions “Call” and “More” (as shown in FIG. 4).

To write “ERIK” would in this case, again, take three joystick moves:

1. press left softkey to select “E”

2. move joystick right

3. press left softkey to select “R”

4. move joystick right

5. press joystick-centre to select “I”

6. move joystick down

7. press joystick-centre to select “K”

Like the other embodiments, the highlights 6 are moved in parallel, i.e. maintaining the distance between the highlighted items.

The present invention results in an efficient navigation in lists and matrixes. Fewer movements of the navigation device are required to highlight an item, and fewer actions are required to select a highlighted item. A person skilled in the art will realise that the invention may be implemented by any suitable combination of hardware and software. Even though some embodiments have been described in detail, it will be appreciated that the invention may be varied within the scope of the attached claims. For instance, the exact form of navigation device and placement of the function keys may be varied and adapted to a particular apparatus or use. The scope of the invention is only limited by the claims below.

1. An apparatus comprising:
a display unit with a screen capable of displaying lists and matrices with highlighted selectable items;
a control unit managing operations of the apparatus and capable of controlling the display unit;
input means connected to the control unit and comprising a navigation device and keys for moving highlights and selecting items, wherein the control unit is arranged to cause the display unit to display items of which a number is highlighted in a defined pattern each such highlighted item representing a selectable item, and being associated with at least one selection key of the input means, and the highlight pattern being movable by means of the navigation device, wherein there is a mutual relationship between said highlighted items with a space between said highlighted items, said space containing not highlighted items, and wherein the highlight pattern is movable while maintaining the mutual relationship between highlighted items.

2. An apparatus according to claim 1, wherein the input means comprises a number of dedicated selection keys.

3. An apparatus according to claim 2, wherein the input means comprises dedicated selection keys placed around the navigation device, and the highlight pattern is reflecting the placement of the selection keys.

4. An apparatus according to claim 3, wherein the highlight pattern comprises four highlighted selectable items, and the input means comprises four dedicated selection keys.

5. An apparatus according to claim 1, wherein the navigation device is assigned softkey functions to act as selection key.

6. An apparatus according to claim 5, wherein the position of the highlight pattern first is selected and confirmed by means of the navigation device, then one of the highlighted selectable items are selected by means of the navigation device.

7. An apparatus according to claim 6, wherein the highlight pattern comprises three highlighted selectable items.

8. An apparatus according to claim 1, wherein the input means comprises function keys, of which a number are assigned softkey functions to act as selection keys.

9. An apparatus according to claim 8, wherein the highlight pattern comprises three highlighted selectable items, and the softkey functions to act as selection keys are assigned to two function keys and to the navigation devices.

10. An apparatus according to claim 1, wherein each selectable item is highlighted with a different appearance, such as colour.

11. An apparatus according to any one of the previous claims, wherein the apparatus is a portable telephone, a pager, a communicator, a smart phone, or an electronic organiser.
